(19) United States
(12) Patent Application Publication
(10) Pub. No.: US 2014/0373429 A1
(43) Pub. Date: Dec. 25, 2014

(54) Ice Fishing Equipment Carrier

(71) Applicant: Alyce Kurowski, Roosevelt, MN (US)

(72) Inventor: Alyce Kurowski, Roosevelt, MN (US)

(21) Appl. No.: 14/308,220

(22) Filed: Jun. 18, 2014

Related U.S. Application Data
(60) Provisional application No. 61/837,871, filed on Jun. 21, 2013.

(51) Int. Cl. A01K 97/01; B62B 13/00; A45F 3/04

(52) U.S. Cl. CPC A01K 97/01; A45F 3/04; B62B 13/00
USPC 43/54.1

(57) ABSTRACT

An ice fishing equipment carrier is provided that comprises a rectangular frame having an open interior and open upper, a sled lower surface, a set of shoulder straps, and an extendable handle. The rectangular frame is comprised of a pair of sidewalls, an open forward and rear wall, an open interior volume and an enclosed base. Elongated fishing equipment and tools are supported within the open interior of the frame, wherein the tools are received through the open upper and secured within the lower interior portion thereof. Retractable shelves are positioned along the base of the frame for storage of smaller equipment and supplies. Finally, the outer surfaces of the frame sidewalls include re hook hangers for suspended equipment therefrom. The frame is shoulder carried or slid along a snow or ice surface to an ice fishing location, whereafter it is free standing and provides a static equipment rack.

### CROSS REFERENCE TO RELATED APPLICATION

This application claims the benefit of U.S. Provisional Application No. 61/837,871 filed on Jun. 21, 2013, entitled “Ice Rod Carrier.” The above identified patent application is herein incorporated by reference in its entirety to provide continuity of disclosure.

### BACKGROUND OF THE INVENTION

1. Field of the Invention

The present invention relates to article carriers and equipment carriers for ice fishing. More specifically, the present invention relates to an ice fishing equipment carrier that allows a user to support various ice fishing gear in a backpack configuration or as a hand-towed assembly along snow and ice.

Ice fishing is a common leisure activity and sport for many that live in a colder climates, and for some is a means of subsistence. The process of ice fishing involves first transporting equipment to a desired body of water, drilling a hole through the layer of ice over the body of water, and fishing through the hole. Equipment for ice fishing is similar to traditional river and lake fishing, with the exception that tools for creating and maintaining the ice fishing hole are generally required, along with an ice scoop to remove ice from the hole during use. In most other respects, the equipment includes various types of fishing rods, lures, and bait that attract fish within the body of water below the ice.

Transporting ice fishing equipment is generally a straight forward process, if one is capable of taking a vehicle to the fishing location. These include automobiles and trucks, as well as all-terrain vehicles and snowmobiles. However, for those without the luxury of a vehicle, or for transport of the equipment along a final leg of the trip no traversable by vehicle, a means of supporting the required equipment is desired.

The present invention relates to a new and improved means of personally transporting equipment, and notably ice fishing equipment without the use of a support vehicle. The device comprises an equipment support that is adapted to provide several locations along which fishing rods and elongated tools can be supported, while also providing storage locations for tackle boxes and ancillary equipment or supplies. The device is a carrier that is adapted to be supported on the back of a user via shoulder straps, or alternatively slide along a snow or ice surface via a sled lower surface and an upstanding handle.

2. Description of the Prior Art

Devices have been disclosed in the prior art that relate to fishing rod and equipment racks. These include devices that have been patented and published in patent application publications, and generally relate to static or wheeled fishing rod racks that are not suited for use over snow or ice, or are not contemplated for shoulder carrying. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 6,360,902 to Searles, which discloses a fishing rod rack that is adapted to be positioned and supported by a boat deck. The rack comprises a base member, a plurality of receptacles in the base member for receiving the butt ends of fishing rods, an upper member, and an arm for lockably retaining the fishing rods within the rack. The rack is a rectangular frame that is adapted to be statically supported via its base member. While disclosing a fishing rod rack having a rectangular frame, the rack of Searles fails to contemplate carrying the rack on one's back or sliding the same along a ground surface. The present invention provides shoulder straps and a sled lower surface for transporting the assembly to a fishing hole.

U.S. Pat. No. 5,657,883 to Badia discloses a mobile fishing rod rack that comprises a frame of vertical side boards, a top board, and a bottom board. The top board includes a plurality of fishing pole notches while the bottom board includes pole holes for accepting the butt of fishing poles therein. Angle boards below the pole holes support the fishing pole butts therebelow, while caster wheels are supported along transverse members extending outward from below the bottom board. The Badia device is similar to the Searles device in construction; however it adds mobility in the form of caster wheels. The Badia device, while disclosing a means to transport the rack, fails to contemplate transport across snow or ice, and further fails to contemplate the use of shoulder straps to shoulder-carry the fishing rod frame as provided herein.

Finally, U.S. Patent Publication No. 2013/0068710 to Cearns discloses a rack for horizontal storage of fishing rods. The rack comprises a plurality of support clamps attached to vertical supports, wherein the vertical supports are supported from the ground, an upstanding wall, or the ceiling. The Cearns device provides a fishing rod support apparatus suitable for storage and display, rather than for transport to a fishing location. The Cearns device is adapted to support rods from an external support in a horizontal condition, while the present invention is adapted to provide a rack for vertically supporting fishing rods in a carrier that can be transported via a shoulder carrying harness or via a lower surface sled.

The present invention provides a transportable fishing rod and ice fishing equipment carrier that provides the features of a rack, together with the ability to be transported from one location to another and across snowy or icy terrain. The carrier includes various supports for different ice fishing equipment and supplies, while providing a user with versatility with respect to the means of transport: shoulder carrying or sliding the carrier over the snow and ice. Once transported, the carrier is a freestanding equipment rack for the user to access its contents.

It is submitted that the present invention is substantially divergent in design elements from the prior art, and consequently it is clear that there is a need in the art for an improvement to existing ice fishing equipment carrier devices. In this regard the instant invention substantially fulfills these needs.

### SUMMARY OF THE INVENTION

In view of the foregoing disadvantages inherent in the known types of ice fishing equipment carrier devices now present in the prior art, the present invention provides a new carrier device that can be utilized for providing convenience for the user when transporting ice fishing rods and equipment to an ice fishing hole.

It is therefore an object of the present invention to provide a new and improved ice fishing equipment carrier device that has all of the advantages of the prior art and none of the disadvantages.

It is another object of the present invention to provide an ice fishing equipment carrier device to provide a rectangular frame that is suited for supporting elongated fishing rods and ice fishing equipment therein, along with support equipment and supplies for a user.

Another object of the present invention is to provide an ice fishing equipment carrier device that can be loaded and its contents secured such that the device is readily transported without the contents readily dislodging from within the carrier.

Yet another object of the present invention is to provide an ice fishing equipment carrier device that is suited for shoulder carrying the same or sliding the carrier over snow and ice using an extendable handle and a snow sled along the base of the device.

A final object of the present invention is to provide an ice fishing equipment carrier device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exemplary embodiment of the present invention.

FIG. 2 shows a perspective view of the present invention in a loaded state, supporting ice fishing equipment and supplies therein.

FIG. 3 shows a smaller embodiment of the present invention.

FIG. 4 shows a view of the carrier of the present invention being shoulder carried by a user.

FIG. 5 shows the carrier of the present invention being slid via the base sled and the extended handle.

### DETAILED DESCRIPTION OF THE INVENTION

Reference is made herein to the attached drawings. Like reference numerals are used throughout the drawings to depict like or similar elements of the ice fishing equipment carrier. For the purposes of presenting a brief and clear description of the present invention, the preferred embodiment will be discussed as used for supporting ice fishing equipment and supplies in a shoulder-carryable or sliding frame. The figures are intended for representative purposes only and should not be considered to be limiting in any respect.

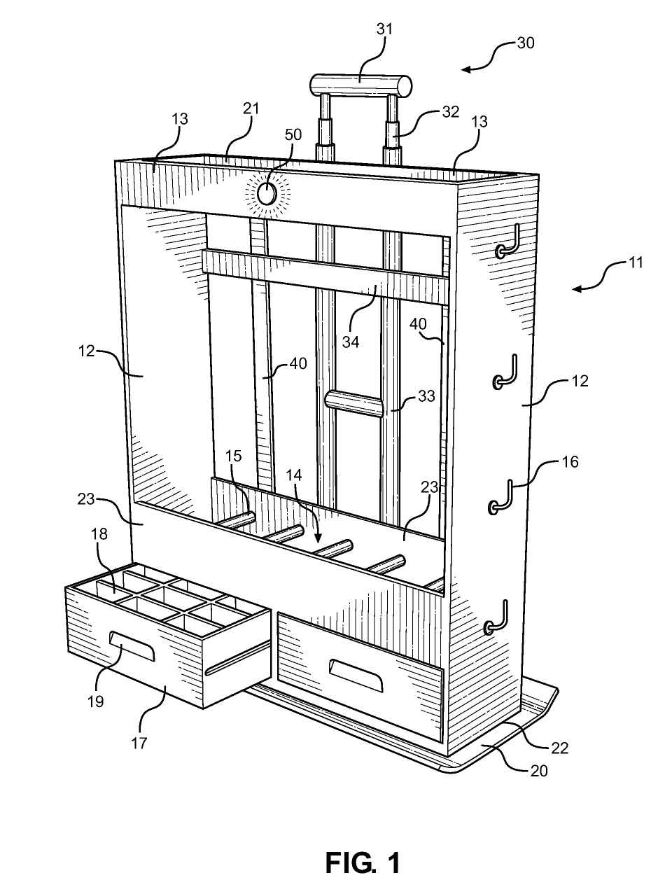

Referring now to FIG. 1, there is shown a perspective view of the ice fishing equipment carrier device of the present invention. The device comprises a rectangular frame 11 having a pair of upstanding sidewalls 12, an open upper 13, an open forward and rear surface, and an enclosed lower portion 23. Above the lower portion 23, the frame 11 is substantially open to allow a user to support upstanding fishing equipment therein and allow ready access thereto. Along the lower portion 23 is a partially enclosed lower interior portion 14 that supports the ends of elongated tools and fishing rods placed therein. The lower interior portion 14 forms a U-shaped trough and includes internal divider 15 to separate and organize tools placed therein. Along the upper portion of the frame 11 there are disposed a pair of upper surfaces 13 that connect the frame sidewalls 12 and enclose the open upper 13. The open upper 13 therefore supports the upper portions of tools placed within the frame 11, wherein the sidewalls 12 and upper surfaces 13 of the frame 11 secure the items therein.

Below the lower interior portion 14 of the frame are disposed optional utility drawers 17, which are slidably positioned within the frame 11 along the base thereof. The drawers 17 comprise an open interior volume, sidewalls, and a hardware article 19 disposed along the exterior surface thereof for opening and closing the drawer. As is well known in the art, the drawers 17 are used to support loose items and other equipment, such as fishing equipment, food, supplies or even clothes therein. Optional internal dividers 18 may further improve organization and separation of loose contents, particularly if fishing tackle is to be placed therein. The dividers 18 comprise one or more upstanding surfaces within the drawer interior that divide the interior volume into smaller portions, preventing items from moving while in the drawer and preventing different items from contacting each other while stored in the drawers.

Along the base 22 of the frame 11 is provided a sled lower surface 20 that is adapted to facilitate sliding of the frame 11 over snow if being dragged thereover. The sled lower surface 20 comprises an elongated surface that extends outward from the base 22 of the frame, and preferably extends upward therefrom. In this way, the ends are flared such that the frame 11 can be tilted and slid at an angle along the snow surface. The sled lower surface is smooth and includes an enlarged surface area. Along the backside of the frame 11 is disposed an extendable handle 30, which is adapted to allow a user to pull the frame 11 along the snow using the sled lower surface 20. The handle attaches along the rear portions of the frame and includes telescoping sections 32, 33 and an upper handle grip 31.

The backside of the frame 11 may further comprise a series of supports for attaching the telescoping sections 33 of the handle 30 thereto. As illustrated in FIG. 1, one embodiment contemplates one or more horizontal slats 34. These slats improve the stability of the frame and provide a location to attach the handle 30 there to. Furthermore, the slats 34 and the frame 11 itself support a pair of shoulder straps 40 such that the assembly can be lifted and supported along the back of a user. This mode of transport may be preferable over long distances, wherein carrying the device like a backpack rather than sliding the device is more efficient.

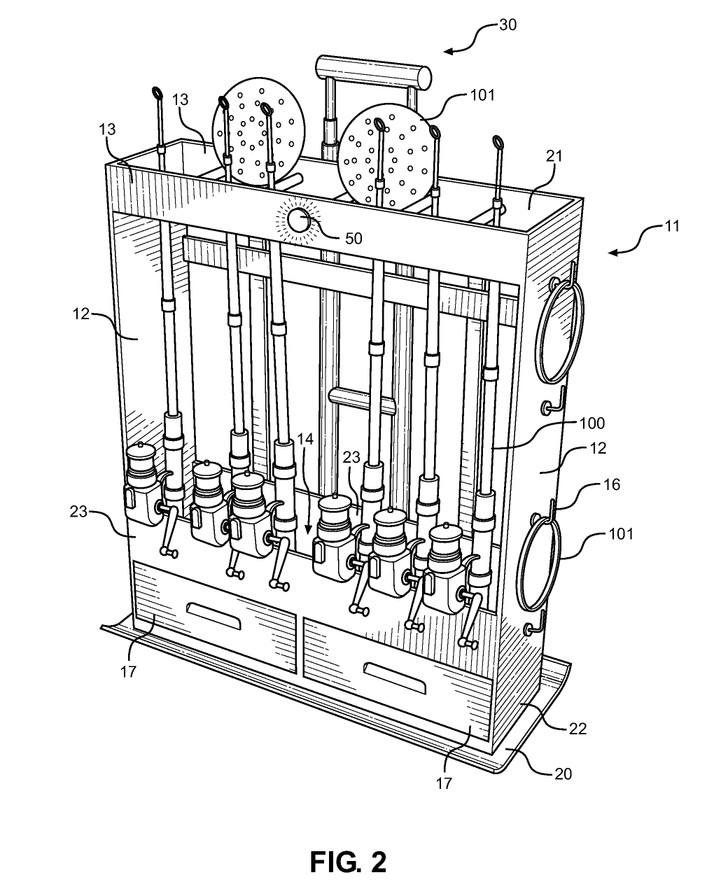

Referring now to FIGS. 1 and 2, there are shown perspective views of the ice fishing equipment carrier device of the present invention in an empty and in a working state, respectively. In a working state, the open frame 11 structure of the present invention supports upstanding fishing rods 100 and other tools 101 in a substantially upright condition therein. The enclosed lower interior portion 14 supports the lower ends thereof, while the lower portions 23 and upper surfaces 13 of the frame 11 prevent the items from sliding out of the interior 21 while the frame 11 is upright. Disposed along the outer surface of the frame sidewalls 12 are a plurality of accessory hooks 16 and similar hardware for supporting hanging items 101. Together with the lower drawers 17, fishing and ice hole accessories can be carried by the frame 11, along with the fishing and ice hole tools themselves.

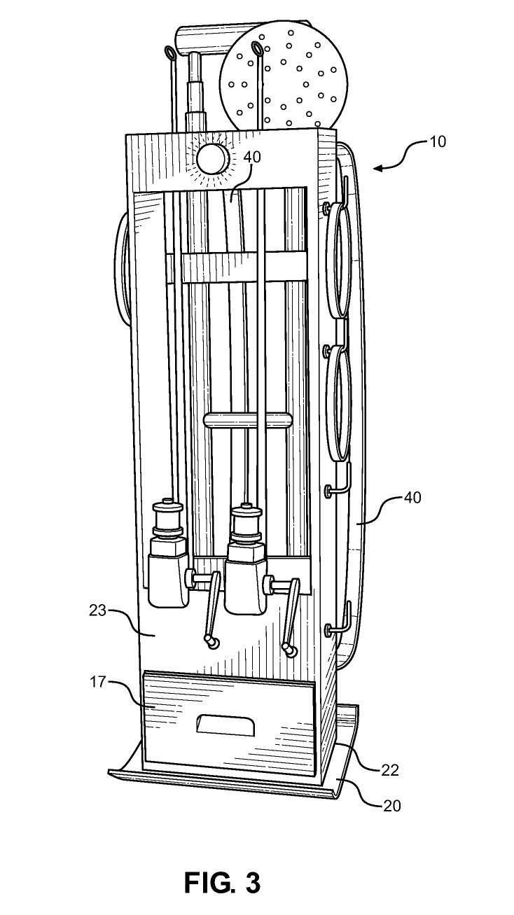

Referring now to FIG. 3, there is shown a view of an alternative embodiment 10 of present invention, wherein the frame comprises a smaller width for supporting fewer items therein. This embodiment contemplates a single drawer 17 or even a small set of drawers along the lower portion 23 of the frame, while the interior volume is condensed to a smaller dimension such that fewer items are carried. The sled lower surface 20 attached to the base includes a smaller surface area, and shoulder straps 40 are provided for carrying the assembly. This embodiment is a smaller size of the same device as provided in FIGS. 1 and 2, wherein the weight carried by the user is reduced and the overall cross section of the assembly is minimized for improve transport and storage thereof.

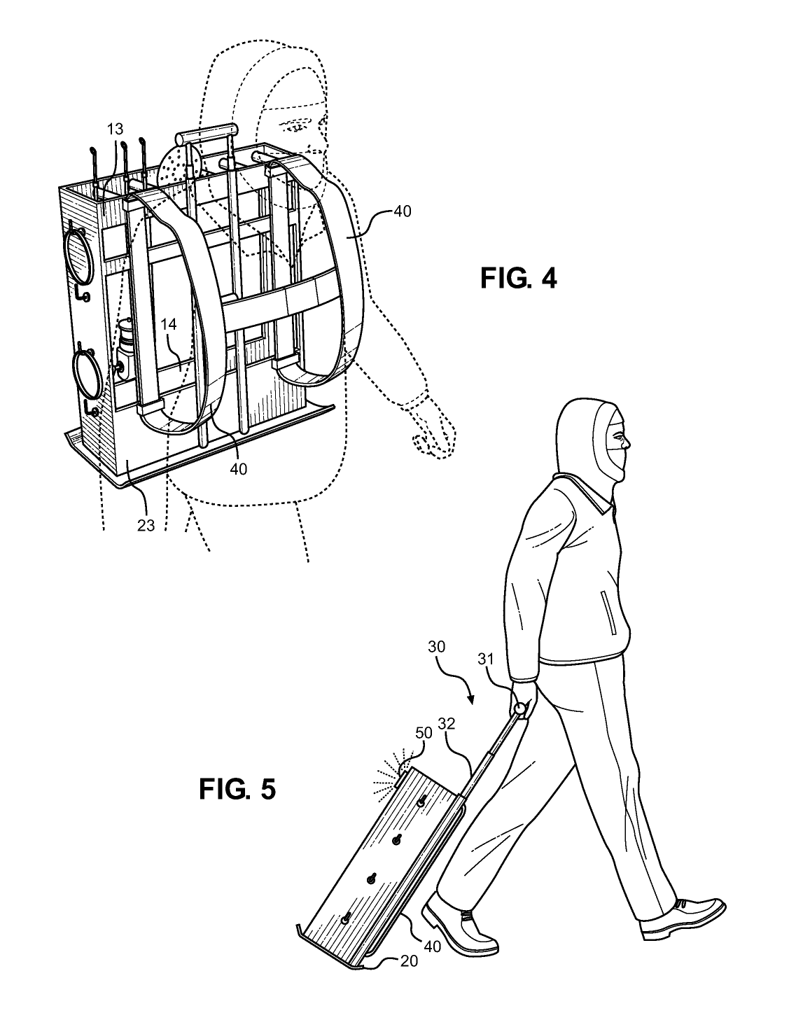

Referring now to FIGS. 4 and 5, there are shown two illustrative methods by which the present invention can be transported. It is contemplated that the present invention be used to support ice fishing equipment, wherein the user may be required to traverse an outdoor area to reach the fishing destination. The present invention provides a sled lower surface 20 such that the user can slid the frame along the snow and ice using the pull handle 31. Furthermore, the device includes a pair of shoulder straps 40 along the backside of the frame, whereby the user can carrying the assembly on his or her back across a distance. The straps 40 are preferably secured to the lower portion 23 and upper surface 13 of the frame and are length adjustable such that the user can comfortably carry the assembly on his or her back and shoulders. Optional back padding may further be provided along the backside of the frame such that the frame and handle 30 does not directly bear against the user while being carried.

A final option on the ice fishing equipment carrying device of the present invention is a light source 50, as shown in FIGS. 1 and 2. The light source is an optional accessory positioned along the frontside portion of the frame such that the user can rest the frame on the ground and illuminate an area in front of the same. The light source includes a battery power source, a lighting fixture such as an LED array or incandescent bulb, and further includes an activation switch and supporting electrical connections for operation thereof. The electrical connections (not shown) can be positioned along the interior of the frame, while the switch can be disposed in any convenient location therealong. Overall, the device supports equipment and the light source 50 provides a means to brighten an area in low light conditions, such as in an ice fishing but or when preparing fishing lures in low light while outdoors. The user can illuminate an area in front of the frame, which includes the drawer interiors when open, wherein tackle and other associated equipment can be visualized and accessed. At the same time the frame interior supports items such as fishing rods, ice scoops, chisels, small hand augers, shovels, and other tools.

Fishermen are often adventurous and engage in the activity at various times, different manners, and in various locations. Many fishermen aim to fish in the early morning hours while it is still dark to catch a larger quantity of fish. Ice fisherman utilize a variety of tools while fishing such as, a fishing pole, ice scoop, tackle box, buckets and other various tools. Often to fish on ice, a fisherman must pass over a slippery ice surface, which can be particularly dangerous during the darkness of the early morning hours. Additionally, carrying multiple tools over a slippery surface can be awkward and even more dangerous. Fisherman are frequently required to make multiple trips to retrieve their tools, which can be time consuming, exhausting, and poses the risk of injury from slipping on the icy surface the fishermen repeatedly traverse.

The present invention describes an ice fishing equipment carrier assembly that assists fisherman traversing terrain with equipment to a fishing location. The device comprises a frame that stores rods and other equipment in a vertical position. The frame includes a sled lower surface and sufficient storage areas for loose tackle and elongated tools. The device enables ice fishermen to conveniently transport ice fishing rods and accessories. The device stores fishing rods, ice scoops and other fishing equipment, and provides a convenient way to carry ice fishing tools to a fishing site and reduces the hassle of carrying multiple items in the arms.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing equipment carrier device, comprising:
a substantially rectangular frame comprising a pair of upstanding sidewalls, an open upper, a forward surface, a rear surface, an open interior, and an enclosed lower portion;
said enclosed lower interior portion comprising a U-shaped trough with an open upper, said enclosed lower interior portion adapted to support the ends of upstanding equipment therein;
said frame further comprising a frontside portion and a backside portion;
an upper surface disposed along said frontside portion and said backside portion, enclosing said open upper between said frontside portion, backside portion, and said pair of upstanding sidewalls;
said frame further comprising a base surface;
said base surface further comprising a sled lower surface having a larger surface area than said base and extending upward and outward from said frontside portion and said backside portion;
a handle disposed along said backside portion.

2) The fishing equipment carrier device of claim 1, further comprising at least one shoulder strap disposed along said backside portion.

3) The fishing equipment carrier device of claim 1, wherein said handle is upwardly extendable and comprises one or more telescoping sections.

4) The fishing equipment carrier device of claim 1, wherein said frame further comprises one or more slidable drawers disposed below said enclosed lower portion.

5) The fishing equipment carrier device of claim 1, wherein one or more accessory hooks are disposed along said upstanding sidewalls.

6) The fishing equipment carrier device of claim 1, further comprising a light source disposed along said frontside portion.

7) The fishing equipment carrier device of claim 1, wherein said U-shaped trough further comprises one or more dividers thereacross.

8) The fishing equipment carrier device of claim 1, wherein said forward surface of said frame comprises an open surface to access said open interior therethrough.

9) The fishing equipment carrier device of claim 1, wherein said rear surface of said frame comprises an open surface to access said open interior therethrough.

10) The fishing equipment carrier device of claim 1, wherein said rear portion further comprises one or more slats thereacross.
